(19) United States
(12) Patent Application Publication
(10) Pub. No.: US 2016/0267553 A1
(43) Pub. Date: Sep. 15, 2016

(54) CONTENT MERCHANDISING SYSTEM

(71) Applicant: Verizon Patent and Licensing Inc., Arlington, VA (US)

(72) Inventors: Matthew SLAGEL, Washington, DC (US); Jeffery Lionel HARRIS, Leesburg, VA (US)

(21) Appl. No.: 14/657,092

(22) Filed: Mar. 13, 2015

(51) Int. Cl. G06Q 30/02; G06F 3/0486; G06F 3/0484; H04L 29/08

(52) U.S. Cl. CPC G06Q 30/0276; H04L 67/141; G06F 3/0486; G06F 3/04842; G06Q 30/0269

(57) ABSTRACT

A method, a device, and a non-transitory storage medium that receives a selection from a user, via a graphical user interface, of any module from a set of modules that each provides an environment to create a content promotion pertaining to content, wherein the set of modules includes a custom module, a feed module, an operations module, a my-list module, and a system module; present a set of parameters to the user based on the selection of any of the set of modules; receive a parameter value, from the user, for each parameter of the set of parameters pertaining to a selected module of the set of modules; generate the content promotion based on the set of parameters and their corresponding parameter values; and present another graphical user interface that includes the content promotion as would be presented to a customer.

### BACKGROUND

A content management system (CMS) (also known as an asset management system (AMS)) provides users the ability to manage, publish, and distribute content. For example, the CMS allows the user to acquire, aggregate and ingest content, edit the content, manage the content based on the metadata attributable to the content, and package, publish and distribute the content. Typically, such systems are designed for content aggregators, distributors and retailers of various content, such as audio and video files, metadata, and various other types of files (e.g., Extensible Markup Language (XML), HyperText Markup Language (HTML), etc.).

### BRIEF DESCRIPTION OF THE DRAWINGS

FIG. 1 is a diagram illustrating an exemplary environment in which an exemplary embodiment of a content merchandising system may be implemented;

FIG. 2A is a diagram illustrating an exemplary content promotion;

FIG. 2B is a diagram illustrating an exemplary graphical user interface of the content merchandising system;

FIGS. 2C-2G are diagrams illustrating an exemplary process for creating a content promotion using a custom module of the content merchandising system;

FIGS. 3A-3E are diagrams illustrating exemplary graphical user interfaces of other modules of the content merchandising system;

FIG. 4 is a diagram illustrating exemplary components of a device that may correspond to one or more of the devices illustrated in the exemplary environment of FIG. 1;

FIG. 5 is a flow diagram that illustrates an exemplary process for creating a content promotion using the content merchandising system; and

FIG. 6 is a diagram illustrating an exemplary main graphical user interface of the content merchandising system.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

For large-scale content distributors, such as a national television service provider, a national wireless service provider, and/or a national Internet service provider, complexities arise by virtue of the amount of content to be distributed and the lack of integration among various systems. For example, an operations user of a large-scale distributor may have to work with disparate systems to provide for the packaging, pricing, promotion, and placement of content directed to end users (e.g., customers). At the very least, such an approach is not efficient and may inhibit the operations user to create and merchandise content or other types of merchandise.

According to an exemplary embodiment, a content merchandising system (CMS) includes an integrated system that provides for the packaging, pricing, promotion, and placement (e.g., distribution) of content. The content merchandising system provides a streamlined and intuitive approach to programming content across various platforms and allows users to manually curate or automatically generate content promotions using a dynamic set of customizable tools. According to an exemplary embodiment, the content merchandising system includes a set of modules, in which each module provides parameters through which content may be grouped and presented to end users. The modules may be used to create as many different variations of content packages as desired, and these content packages may then be used and saved by the content merchandising system as unique entities. Once a content promotion is created, the content promotion may be placed within a graphical user interface or other medium geared toward to an end user. For example, the module allows a user to arrange the content promotion, via a drag-and-drop function, within a candidate graphical user interface that is to be presented to the end user.

According to an exemplary embodiment, the content merchandising system has access to content availability scheduling and is configured to interface with other systems, such as a recommendation engine and a discovery engine, to provide the option to automate and customize the selection of the content and the creation of the content promotion.

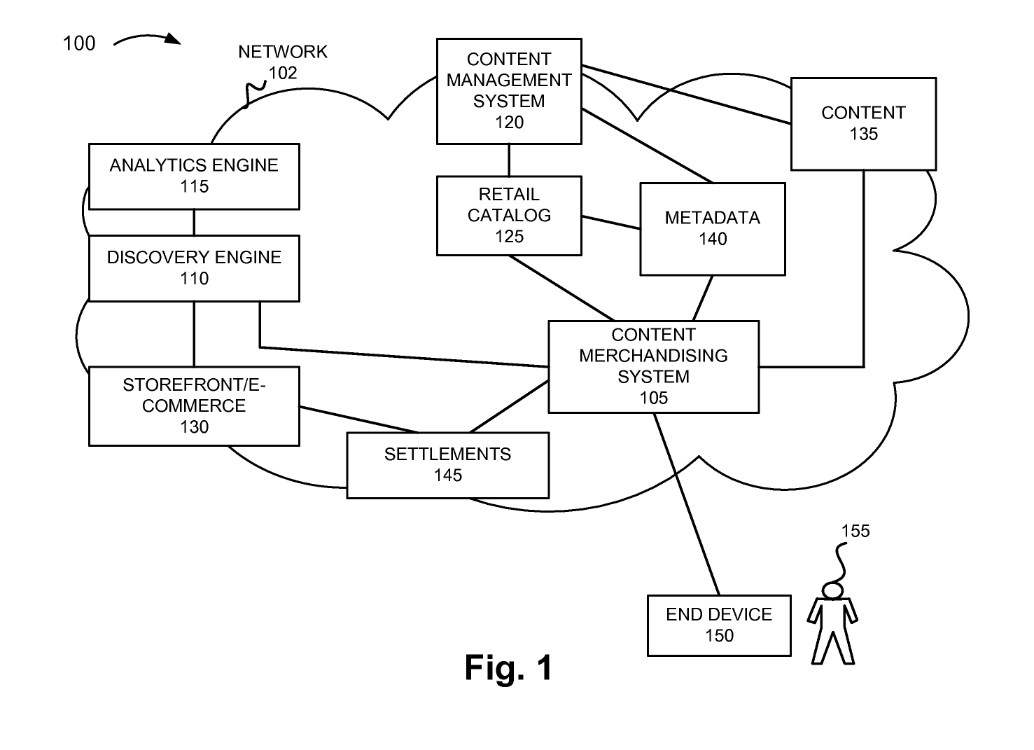

FIG. 1 is a diagram illustrating an exemplary environment 100 in which an exemplary embodiment of a content merchandising system may be implemented. As illustrated, environment 100 includes a network 102. Network 102 includes a content merchandising system 105, a discovery engine 110, an analytics engine 115, a content management system 120, a retail catalog device 125, a storefront/e-commerce device 130, a content device 135, a metadata device 140, and a settlements device 145. Environment 100 also illustrates an end device 150 and a user 155.

Environment 100 may be implemented to include wired, optical, and/or wireless connections among the devices illustrated. A connection may be direct or indirect and may involve an intermediary device not illustrated in FIG. 1. For example, environment 100 may include a gateway device, a security device, a router, a switch, etc. Additionally, or alternatively, a connection may involve an intermediary network not illustrated in FIG. 1. For example, environment 100 may include an access network, a local area network, etc. Additionally, the number, type (e.g., wired, wireless, etc.), and the arrangement of connections between the devices are exemplary.

A device may be implemented according to a centralized computing architecture, a distributed computing architecture, or a cloud computing architecture (e.g., an elastic cloud, a private cloud, a public cloud, etc.). Additionally, a device may be implemented according to one or multiple network architectures (e.g., a client device, a server device, a peer device, a proxy device, and/or a cloud device).

The number of devices, the number of networks, and the configuration in environment 100 are exemplary. According to other embodiments, environment 100 may include additional devices, fewer devices, and/or differently arranged devices, than those illustrated in FIG. 1. For example, environment 100 may include multiple content devices 135, metadata devices 140, or other types of devices illustrated in FIG. 1. Also, according to other embodiments, one or more functions and/or processes described as being performed by a particular device may be performed by a different device, or some combination of devices.

Network 102 may include one or multiple networks of one or multiple types. For example, network 102 may be a private network, a packet-switched network, a wide area network, a metropolitan area network, an Internet Protocol (IP) network, the Internet, the Web, etc.

Content merchandising system 105 includes a device that provides an integrated system for the packaging, pricing, promotion, and placement of content. According to an exemplary embodiment, content merchandising system 105 includes a set of modules that allows user 155 to merchandise content. According to an exemplary embodiment, the set of modules includes a custom module, a feed module, an operations module, a my-list module, and a system module. According to an exemplary embodiment, each of the modules provides a graphical user interface that allows user 155 of content merchandising system 105 to interact with each of the modules, set parameter values pertaining to parameters that are offered within each module, etc., as described herein. User 155 is able to create a content promotion within each module.

The custom module provides for the selection of content based on various parameter values selected by user 155. For example, user 155 may select content based on various genres, release dates, MPAA ratings, prices, keywords, running times of content, end user device types, etc., as described herein. The custom module provides user 155 with the greatest degree of customization and flexibility to select content relative to the other modules.

The feed module provides for the selection of merchandising feeds from third parties (e.g., a content provider). For example, a merchandising feed may include a collection or a pre-grouping of content that a third party wishes the service provider to promote. The merchandising feed may also include the advertisement or promotion for the collection or the pre-grouping of content. For example, the advertisement may include posters, text, and other visual elements, audio elements, etc., which are designed to promote the content.

The operations module provides for the manual curation of content. For example, user 155 may perform a search of content based on key terms and then manually select content from a result of the search.

The my-list module provides for the importing of favorites and bookmarked content pertaining to a customer. For example, the customer may bookmark a few movies that the customer intends to watch. The my-list module obtains this information and generates a content promotion based on the bookmarked content.

The system module provides for the automated selection of content based on general or pre-configured categories of content, such as “popular”, “top titles”, “recommendations”, “recently watched”, “box office performance” and “customer specific”. The system module may also select content based on a recommendation engine. For example, the recommendation engine may select content based on criteria pertaining to a customer or a group of customers.

Discovery engine 110 includes a device that creates customized content recommendations by using elements, such as metadata, keywords, viewership statistics, user viewing habits, and user preferences. Discovery engine 110 can create personalized experiences for customers by displaying content deemed most relevant to them based on a combination of these elements.

Analytics engine 115 includes a device that provides detailed statistical information that can be used to make marketing/merchandising decisions, such as top performing content, click-through or selection statistics, conversion percentages, etc.

Content management system 120 includes a content management system. For example, content management system 120 provides for the ingestion and processing of content and metadata from content device 135 and metadata device 140. Content management device 120 may also generate and store a master catalog of the content and the metadata.

Retail catalog 125 includes a device that manages and stores a retail catalog. The retail catalog indicates content and metadata offered by the service provider to customers.

Storefront/e-commerce device 130 includes a device that stores and makes available to customers content and content promotions. For example, storefront/e-commerce device 130 stores graphical user interfaces created by user 155 of content merchandising system 105.

Content device 135 includes a device that stores content. For example, the device may be implemented as a content repository or a content registry. The content device 135 may be managed by the service provider and/or a third party. According to an exemplary implementation, the content includes audio and video content, such as movies, trailers, and television content (e.g., premium channel content, television shows, etc.). Additionally, for example, the content may include metadata, title rights and avails information, and other forms of media (e.g., pictures, posters, text, etc.).

Metadata device 140 includes a device that stores metadata. For example, the device may be implemented as a metadata repository or a metadata registry. The metadata device 140 may be managed by the service provider and/or a third party. According to an exemplary implementation, the metadata pertains to audio and video content.

Settlements device 145 includes a device that processes content sales and rental statistics and provides information necessary to pay the content providers.

End device 150 includes a communicative and computational device that communicates with content merchandising system 105. End device 150 may include a web browser or other type of software (e.g., client software, application, etc.) that allows user 155 to interact with content merchandising system 105. End device 150 may be implemented as a mobile device or a non-mobile device. By way of example, end device 150 may be implemented as a computer (e.g., a desktop computer, a laptop computer, a palmtop computer), a smartphone, a tablet, a netbook, or similar type of user device. User 155 is a user that operates end device 150 and uses content merchandising system 105. For example, user 155 may be an operations user that uses content merchandising system 105 via end device 150.

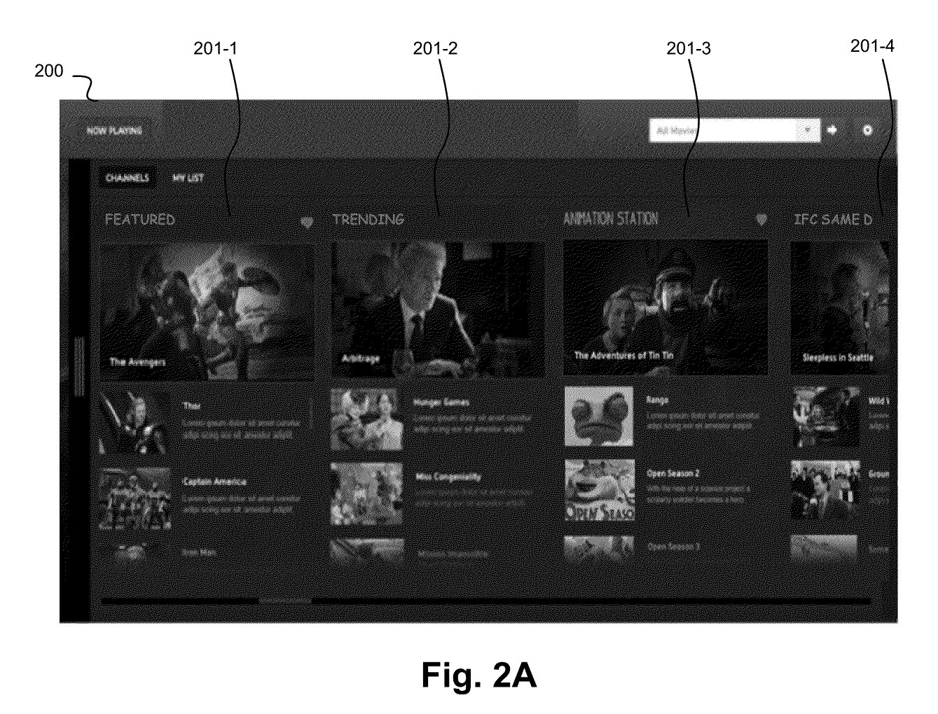

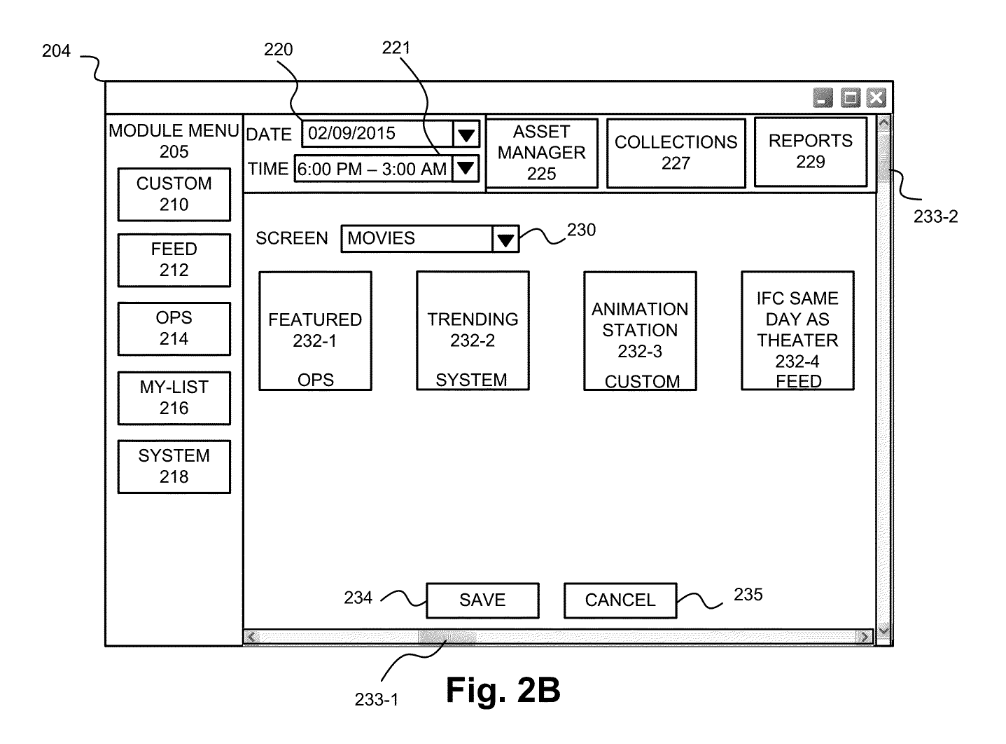

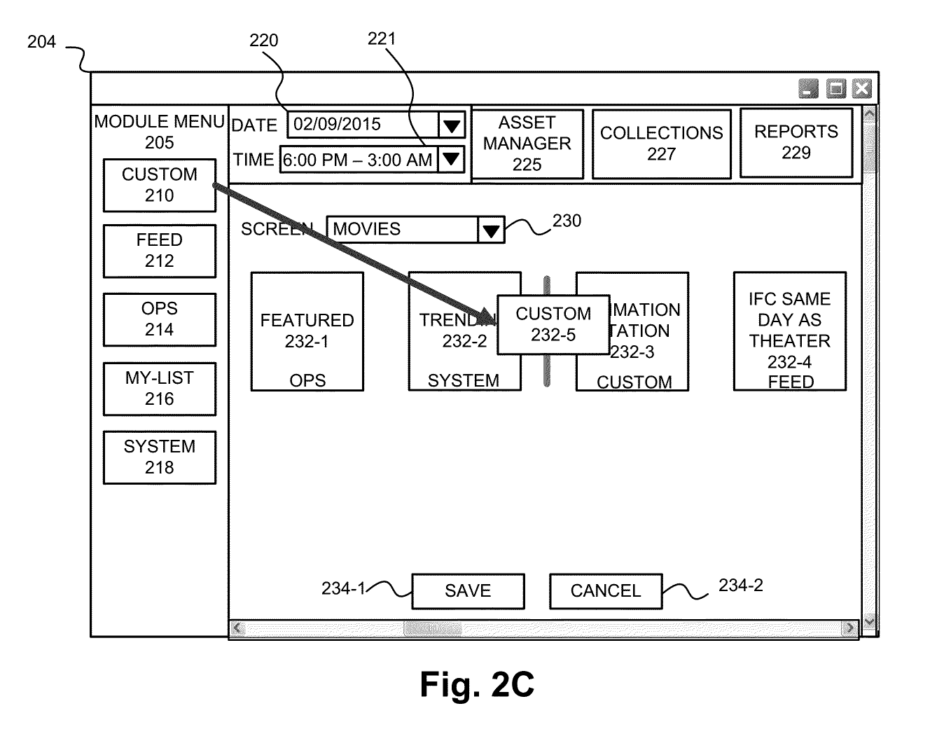

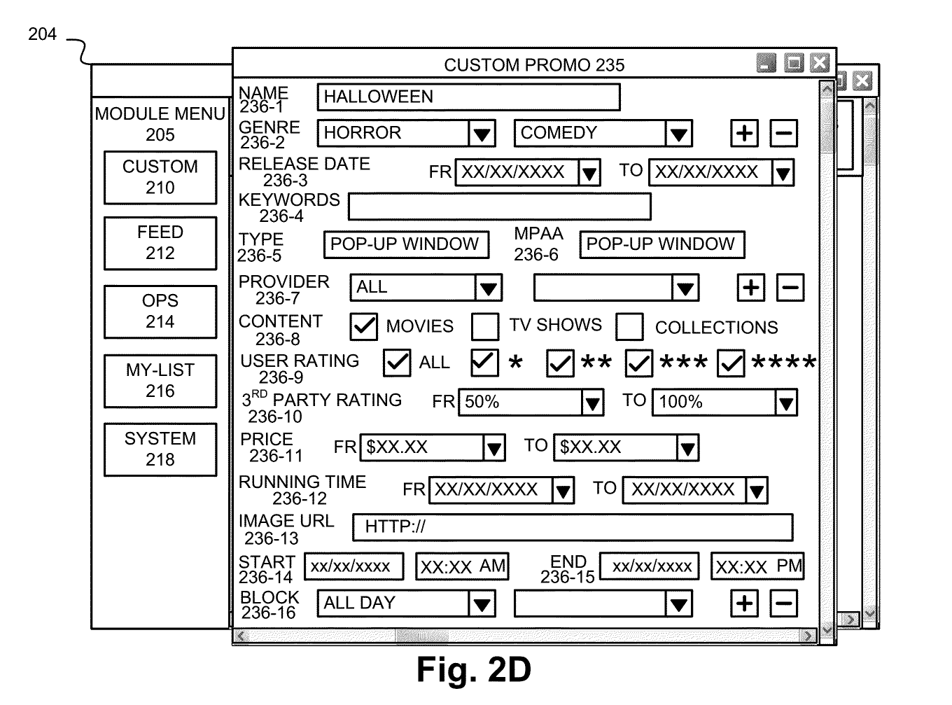

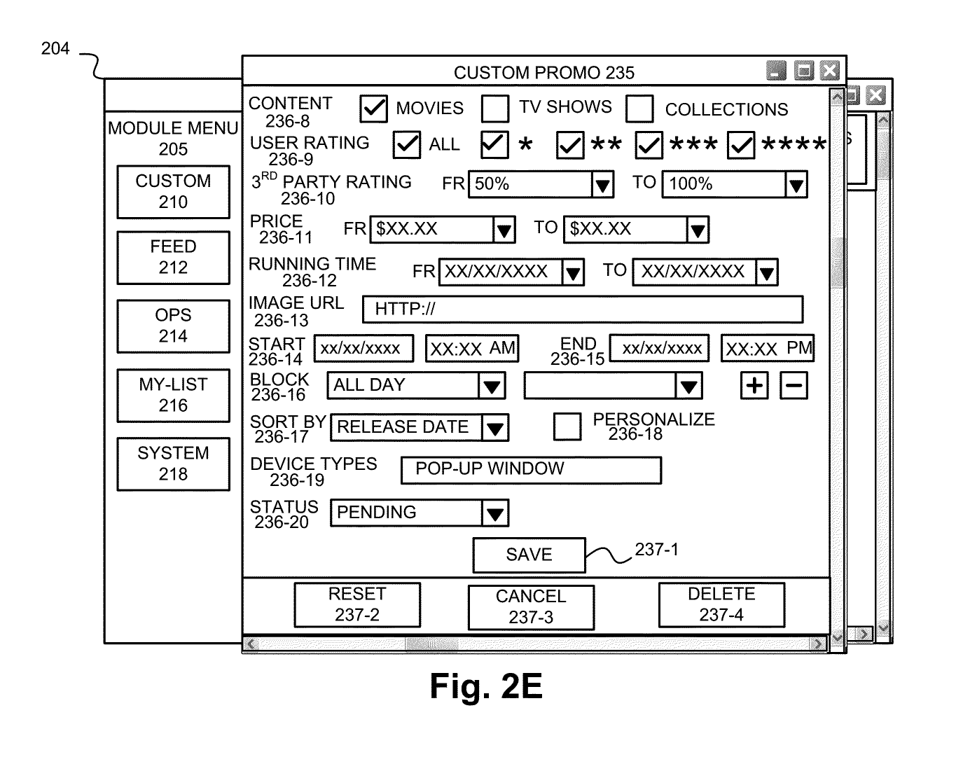

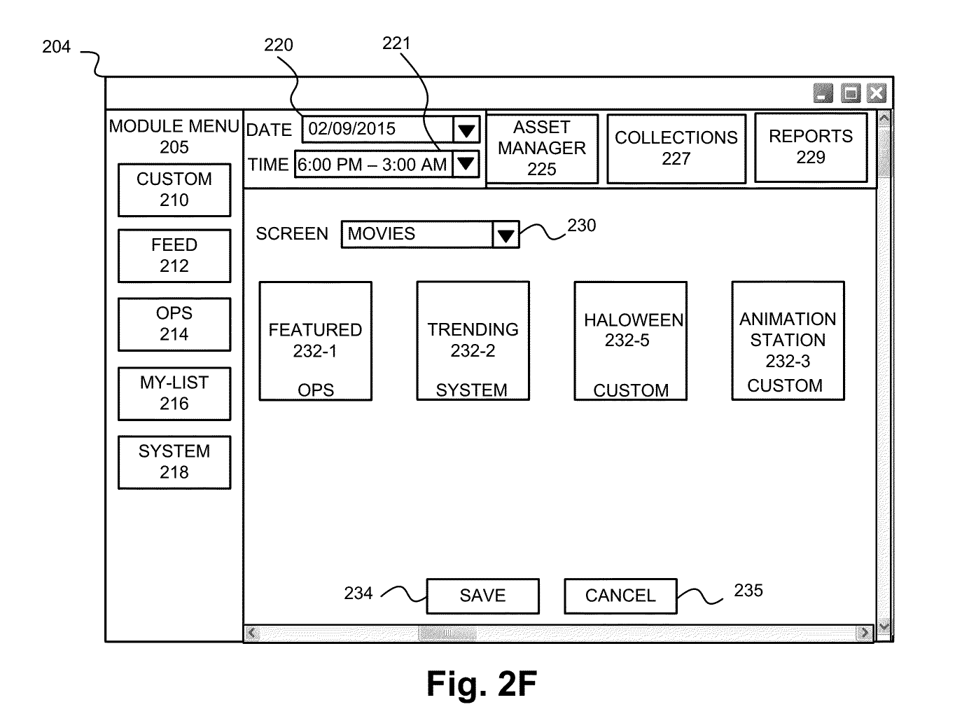

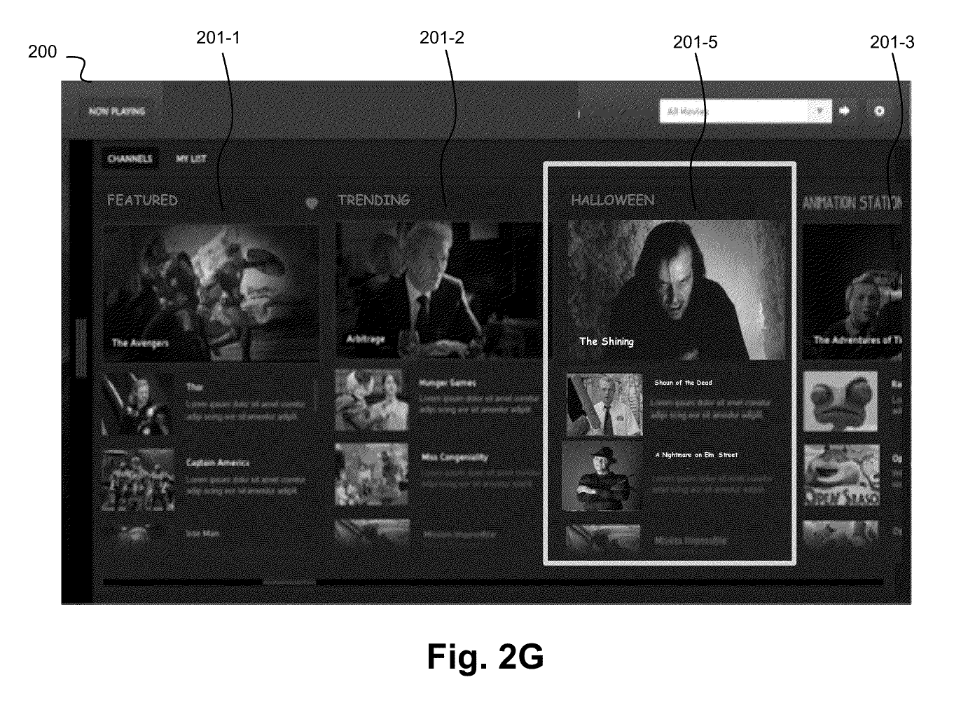

FIG. 2A is a diagram illustrating an exemplary content promotion. As illustrated, the content promotion is in the form of a graphical user interface 200 that includes promotions 201-1 through 201-4 (also referred to as promotions 201, or individually or generally as promotion 201). For example, promotion 201-1 is titled “featured”; promotion 201-2 is titled “trending”; promotion 201-3 is titled “animation station”; and promotion 201-4 is titled “IFC same day as theater.” Each promotion 201 includes pictures or posters along with text. According to this example, each promotion 201 pertains to a package of content (e.g., multiple movies).

FIG. 2B is a diagram illustrating an exemplary graphical user interface 204 of content merchandising system 105. Graphical user interface 204 allows user 155 to create a content promotion package, such as the promotions 201 included in graphical user interface 200. For example, as illustrated, featured 232-1 corresponds to promotion 201-1 titled “Featured”; trending 232-2 corresponds to promotion 201-2 titled “Trending”; animation station 232-4 corresponds to promotion 201-3 titled “Animation Station”; and IFC same day as theater 232-4 corresponds to promotion 201-4 titled “IFC Same Day As Theater”. Also illustrated is the name of the module by which promotion 201 was created. For example, featured 232-1 was created by user 155 via an operations (ops) module 214, trending 232-2 was created by user 155 via system module 218, animation system 232-3 was created by user 155 via a custom module 210, and IFC same day as theater 232-4 was created by user 155 via a feed module 212.

As illustrated in FIG. 2B, graphical user interface 204 includes a module menu 205. Module menu 205 includes a user interface that allows user 155 to select from a set of modules to create a content promotion package. As illustrated, module menu 205 includes custom module 210, feed module 212, operations module 214, a my-list module 216, and system module 218. As illustrated and described further below, each of the modules provides a graphical user interface that allows user 155 to set parameter values pertaining to parameters offered through each module.

As further illustrated, graphical user interface 204 includes a date setting 220, which indicates a date or dates that the content promotion package will be available to customers (e.g., displayed to customers); and a time setting 221, which indicates a time or times on the date or dates that the content promotion package will be available to customers. An asset manager 225, when selected by user 155, takes user 155 to an asset management page, a collections 227, when selected by user 155, takes user 155 to a collections creation page, and a reports 229, when selected by user 155, takes user 155 to a report generation page. End user screen 230 allows user 155 to select the corresponding customer screen pertaining to the content promotion package. For example, user 155 may select an end user screen, such as “movies.”

As described further below, a module (e.g., custom module 210, etc.) from module menu 205 may be dragged and dropped into a desired location. Additionally, user 155 may rearrange featured 232-1, trending 232-2, animation station 232-4, and IFC same day as theater 232-4, as desired. Graphical user interface 204 allows user 155 to save, via a save button 234-1, or cancel, via a cancel button 234-2, any edits or changes during the creation of the content promotion package. Additionally, graphical user interface 204 also includes scrolling elements 233-1 and 233-2, which allows user 155 to scroll horizontally and vertically.

FIGS. 2C-2G are diagrams illustrating an exemplary process for creating a content package promotion using custom module 210 of content merchandising system 105. Referring to FIG. 2C, assume that user 155 of content merchandising system 105 is tasked with creating a new customer content package promotion titled “Halloween.” User 155 accesses content merchandising system 105 via end device 150 and establishes a session. User 155 navigates to the content promotion management section of content merchandising system 105 and selects an ongoing content promotions package. User 155 is presented with graphical user interface 204. Graphical user interface 204 includes the current content promotion lineup (e.g., featured 232-1, trending 232-2, animation station 232-4, and IFC same day as theater 232-4), and module menu 205 from which user 155 may select a suitable module to create the new customer content package promotion titled “Halloween.” As illustrated, assume user 155 selects custom module 210 to create the new customer content package promotion. User 155 drags and drops a custom 232-5 to a desired location, such as between trending 232-2 and animation station 232-3. Thereafter, user 155 double clicks on or otherwise opens custom 232-5 to access a graphical user interface 235.

Referring to FIG. 2D, graphical user interface 235 includes an array of parameters that user 155 may select and for which user 155 may set values. For example, as illustrated, user 155 may set a parameter value for name field 236-1, which indicates a name of the promotion. In this example, user 155 enters “Halloween” as the name of the promotion. Additionally, graphical user interface 235 includes other parameters for which user 155 may set values, such as a genre field 236-2, which pertains to a genre and/or sub-genre of content, and a release date field 236-3, which pertains to a release date for a content (e.g., a “from” date and a “to” date). For example, the release date may be a theatrical release date, a date that the content was made available to consumers (e.g., a straight to DVD or Blu-ray date), or some other type of release date. Additionally, as illustrated, user 155 may enter keywords into a keywords field 236-4, which allows user 155 to search for content based on keywords. For example, in view of user's 155 selection of “Halloween” for name field 236-1, user 155 may enter keywords, such as “Dracula”, “Frankenstein”, etc. A type field 236-5 provides a pop-up window (not illustrated) that allows user 155 to select from various content types, such as “all”; “subscription video-on-demand” (SVOD) content type, which requires a customer to subscribe to a particular service (e.g., a premium television channel service, etc.) to view the content; a “rent” content type in which content can be rented by a customer; a “buy” content type in which content can be purchased by a customer; and a “buy DC” content type, in which a digital copy (DC) of the content can be purchased by a customer. An MPAA rating field 236-6 provides a pop-up window (not illustrated) that allows user 155 to select from various MPAA ratings, such as “all”; “G”; “PG”; “R”; “NC-17”; “Not Rated”; and “Unrated”. A provider field 236-7 allows user 155 to select a content provider. For example, the content provider may be a movie studio, a network (e.g., HBO, Showtime, Starz, Epix, etc.), or other type of entertainment company. A content 236-8 field allows user 155 to select from different types of content, such as “movies”; television (“TV shows”); and “collections.” “Collections” is described further below in relation to collections 227 in which “collections” may be a parameter that is selectable among multiple modules, such as custom module 210, operations module 214, etc.

A user rating field 236-9 provides user 155 with the option to select content that has a certain user rating, such as “all”; one star, two stars, three stars, or four stars. According to other examples, user rating field 236-9 may be measured based on other metrics (e.g., numbers, percentages, etc.). A third (3rd) party rating field 236-10 provides user 155 with the option to select content that has a certain third party rating. For example, third party rating field 236-10 provides user 155 with the option to select content within a range of percentages (“from” through “to”). According to other examples, the third party rating may be measured based on other metrics (e.g., stars, numbers, etc.). A price field 236-11 allows user 155 to set a price for the content or a range of prices. Although not illustrated, user 155 may set a different price for the content depending on various criteria (e.g., high-definition (HD), standard definition (SD), 4K, buy, rent, etc.). A running time field 236-12 allows user 155 to set a running time of the content. For example, user 155 may select a range of running times from 1 hour through 1 hour and 30 minutes. An image Uniform Resource Locator (URL) field 236-13 allows user 155 to select a network address from which an image for the “Halloween” promotion may be obtained. For example, user 155 may enter an HTTP address. A start field 236-14 allows user 155 to set a start date and start time, and an end field 236-15 allows user 155 to set an end date and an end time for the “Halloween” promotion. A block field 236-16 allows user 155 to set a time period during which the “Halloween” promotion is displayed to customers. For example, “Halloween” promotion may include adult or gory content in which user 155 may elect to have the “Halloween” promotion displayed to customers only during the evening hours. User 155 may select this time parameter via block field 236-16. According to other examples, user 155 may select an “all day” value, a “morning” value, etc.

Referring to FIG. 2E, assume user 155 scrolled further downward and additional parameters are provided for user 155 to select from graphical user interface 235. For example, a sort by field 236-17 allows user 155 to sort content by any of the previously specified parameters, such as release date, user rating, etc. A personalize field 236-18 allows user 155 the option to personalize the “Halloween” promotion towards a customer. For example, a recommendation engine (e.g., discovery engine 110) may filter available content that has been selected based on the parameter values chosen by user 155, and further refine the selection process based on customer information. For example, the recommendation engine may analyze the content based on a viewing history of the customer, any user preferences the customer has stored, customer ratings of content, demographics pertaining to the customer, etc. In this way, user 155 may provide a customized and personalized “Halloween” promotion to the customer.

A device types field 236-19 provides a pop-up window (not illustrated) that allows user 155 to select from various end devices used by customers. For example, the pop-up window gives user 155 options, such as “all”; “Android Mobile”; “Android Tablet”; “iOS Mobile”; “iOS Tablet”; “PS3” (Playstation 3); “PS4” (Playstation 4); “Roku”; “Samsung BluRay”; “Samsung TV”; “Web”; “Xbox”; etc. According to other examples, various other types or categories may be provided to user 155, such as type of service for delivering the content (e.g., wireless or mobile, television, Internet, etc.), more general end device categories, such as mobile device, television, game system, etc. A status 236-20 field allows user 155 to set a status of the “Halloween” promotion or the status of the entire content package promotion lineup. For example, status field 236-20 may provide various statuses, such as “pending”; “active”; “not active”; “completed”; “disabled”; etc. As further illustrated, graphical user interface 235 includes various buttons, such as a save button 237-1, a reset button 237-2, a cancel button 237-3, and a delete button 237-4. Save button 237 allows user 155 to save his or her progress and exit, or save his or her progress and continue editing. Reset button 237-2 allows user 155 to reset all parameter values pertaining to the parameters offered via graphical user interface 235. Cancel button 237-3 allows user 155 to cancel any edits or changes, and delete button 237-4 allows user 155 to delete custom 232-5. According to this exemplary process, assume user 155 selects save button 237 and opts to save and exit. Referring to FIG. 2F, the new content package promotion is illustrated as Halloween 232-5, along with the pre-existing promotions. FIG. 2G is a diagram illustrating an exemplary content package promotion. For example, graphical user interface 200 illustrated in FIG. 2G is an edited version of graphical user interface 200 illustrated in FIG. 2A, which includes the custom content package promotion titled “Halloween.” The “Halloween” promotion 201-5 is generated based on the parameter values set by user 155 via graphical user interface 235.

In view of content merchandising system 105, user 155 has the ability to quickly and intelligently program content offerings to customers. Current merchandising processes may be manual, involve multiple departments, and require weeks of advanced notice. In contrast, content merchandising system 105 allows user 155 to process merchandising requests immediately, thereby cutting down on operations costs, reducing potential for process errors, and allowing the service provider to quickly merchandise content and take advantage of current events and opportunities. Described below are additional exemplary graphical user interfaces pertaining to other modules included in module menu 205.

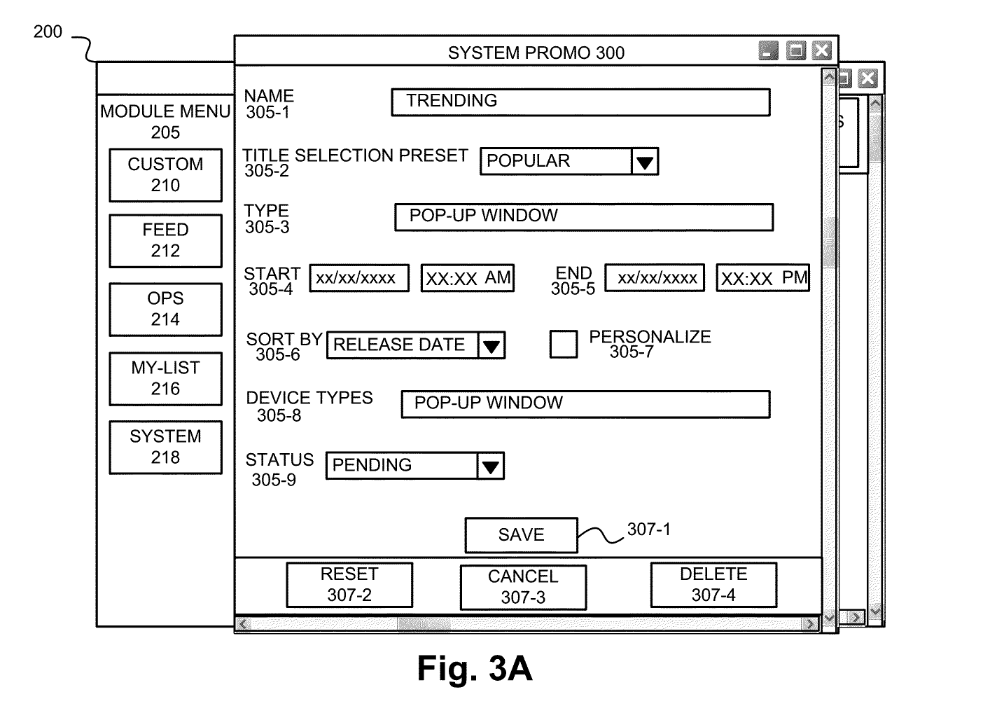

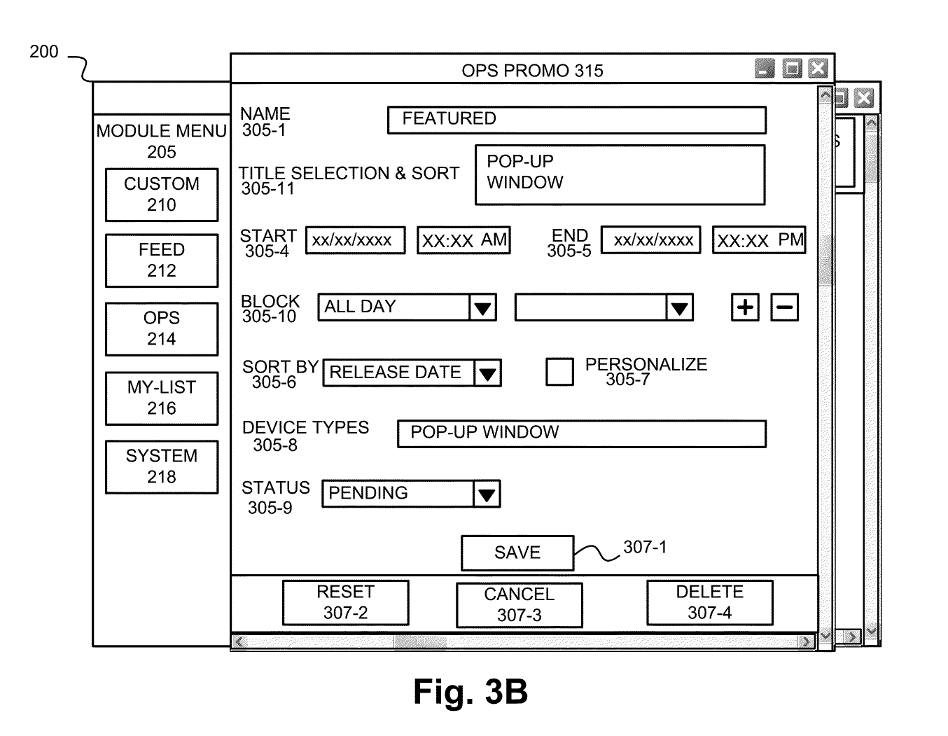

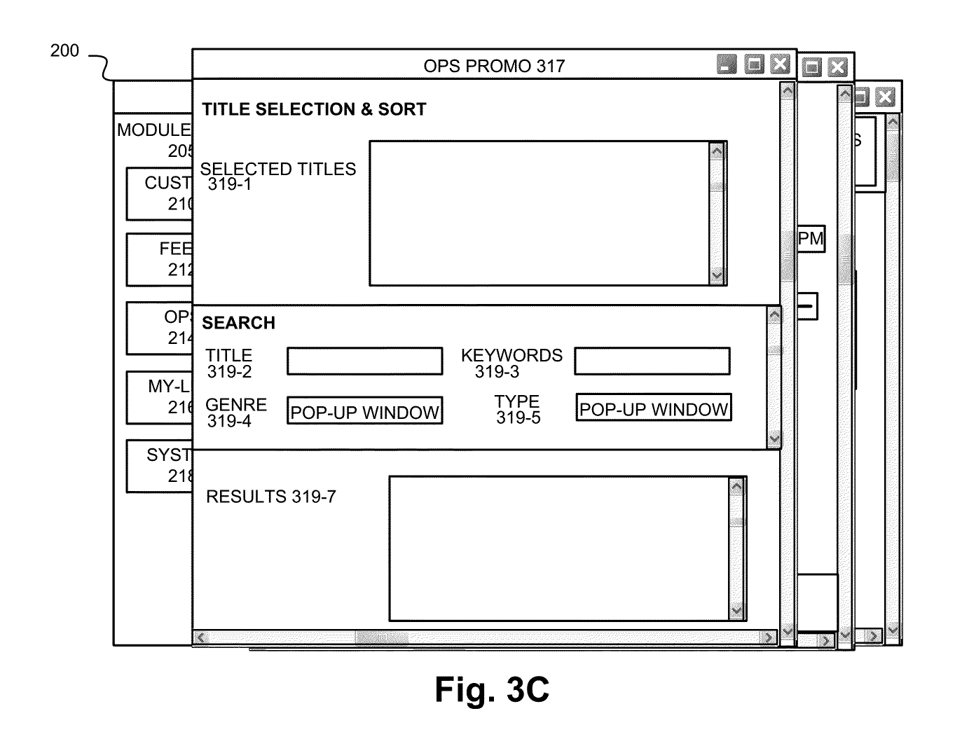

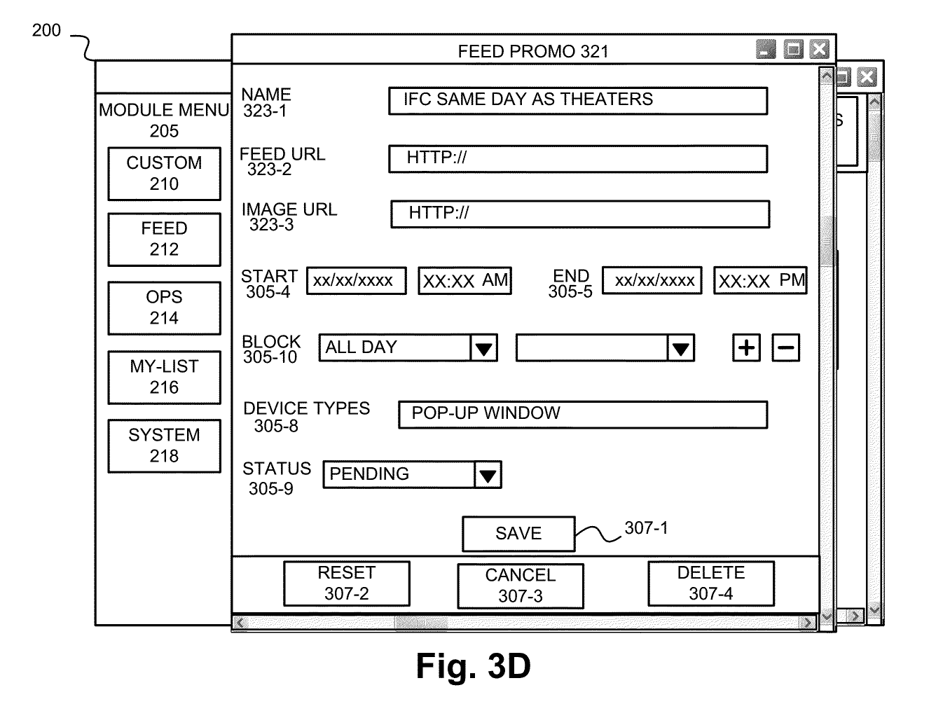

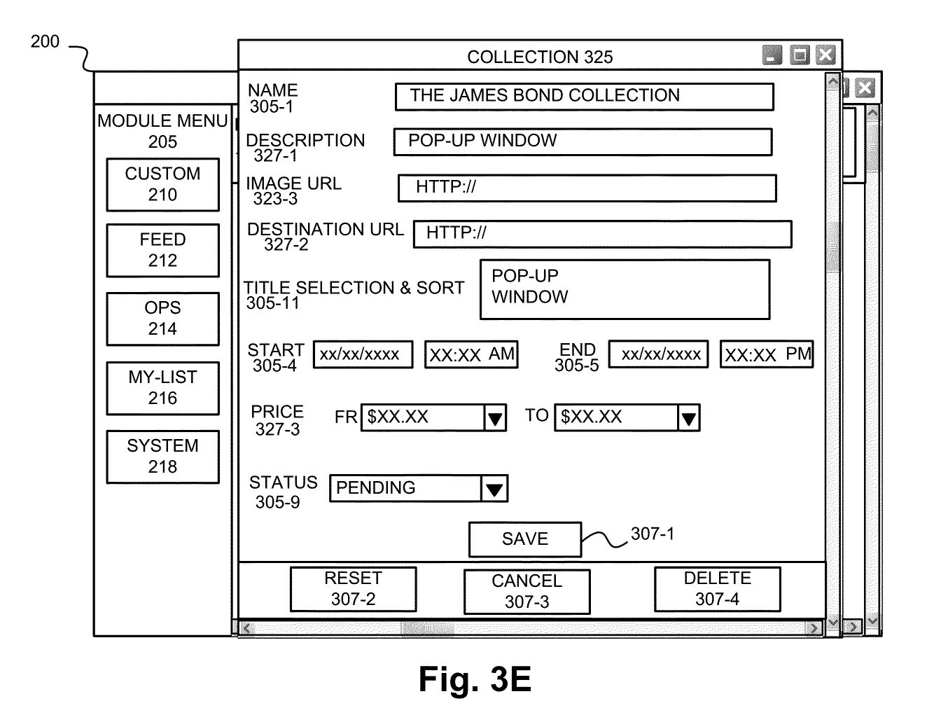

FIGS. 3A-3E are diagrams illustrating exemplary graphical user interfaces of other modules of the content merchandising system 105. For example, FIG. 3A illustrates an exemplary graphical user interface 300 pertaining to system module 218. As illustrated, graphical user interface 300 includes a name field 305-1, which allows user 155 to set a name (e.g., “Trending”) for the content package promotion. A title selection preset field 305-2 allows user 155 to select a category of content. For example, title selection preset field 305-2 may provide various pre-configured categories, such as “popular”; “top titles”; “recommendations”; “recently watched”; “box office performance”; and “customer specific”. For example, “customer specific” may denote content that is linked to a customer based on an attribute of the customer and an attribute of the content. By way of way of example, the geographical location of the customer may be the linking attribute. Based on this example, the title “Good Will Hunting” may be selected as candidate content for customers that live in the Boston area since the story of “Good Will Hunting” takes place in the Boston area. Other types of linking attributes may be implemented based on demographics pertaining to the customers, such as age, profession, income level, etc. For example, the profession of the customers may be a linking attribute. For example, customers that are stockbrokers may be linked to content whose storyline involves Wall Street, such as the movie “Wall Street”, “The Wolf of Wall Street”, etc. Additionally, or alternatively, a combination of linking attributes may be used (e.g., profession and geographical location, etc.). A start field 305-4 and an end field 305-5 allows user 155 to select the start date and time, and the end date and time of the “Trending” promotion. A sort by field 305-6, a personalize field 305-7, a device types field 305-8, and a status field 305-9 are parameters similar to those previously described in relation to FIG. 2E (e.g., sort by field 236-17, personalize field 236-18, device types field 236-19, and status field 236-20). Additionally, referring to FIG. 3A, a save button 307-1, a reset button 307-2, a cancel button 307-3, and a delete button 307-4 provide functionality similar to that previously described in relation to FIG. 2E.

FIG. 3B illustrates an exemplary graphical user interface 315 pertaining to operations module 214. As illustrated, graphical user interface 315 includes a name field 305-1, which allows user 155 to set a name (e.g., “Featured”) for the content package promotion. A title selection and sort field 305-11 provides a pop-up window. FIG. 3C illustrates an exemplary pop-up window 317 for title selection and sort field 305-11. As illustrated, pop-up window 317 includes a search area within pop-up window 317, which includes a title field 319-2, a keywords field 319-3, a genre field 319-4, and a type field 319-5. Title field 319-2 allows user 155 to enter a specific title of a content. Keywords field 319-3 allows user 155 to enter keywords to search for content. Genre field 319-4 provides another pop-up window (not illustrated) from which user 155 may select a genre and/or a sub-genre of content. Type field 319-5 provides a pop-up window (not illustrated) similar to that previously described for type field 236-5, which allows user 155 to select from various content types “SVOD”, “buy”, “rent”, etc. Results field 319-7 provides a search result, such as a listing of titles of content, which satisfy the search criteria. Selected titles field 319-1 allows user 155 to see the titles selected from results field 319-7. Referring back to FIG. 3B, start field 305-4, end field 305-5, sort by field 305-6, personalize field 305-7, device types field 305-8, status field 305-9, save button 307-1, reset button 307-2, cancel button 307-3, and delete button 307-4 provide similar functionality as previously described in relation to FIG. 3A and elsewhere in this description. Block field 305-10 allows user 155 to block the content package promotion, as previously described in relation to block field 236-16 of FIG. 2D.

FIG. 3D illustrates an exemplary graphical user interface 321 pertaining to feed module 212. As illustrated, graphical user interface 321 includes a name field 323-1, which allows user 155 to set a name (e.g., “IFC Same Day As Theaters”) for the content package promotion. A feed URL field 232-2 allows user 155 to enter or select from a list (not illustrated) a network address (e.g., a URL) from which a content package or a content package and promotion has already been assembled by a content provider. An image URL field 323-3 allows user to enter or select from a list (not illustrated) a network address (e.g., a URL) from which an image may be selected to use for creation of the content package promotion. Start field 305-4, end field 305-5, block field 305-10, device types field 305-8, status field 305-9, save button 307-1, reset button 307-2, cancel button 307-3, and delete button 307-4 provide functionalities similar to those previously described elsewhere in this description.

FIG. 3E illustrates an exemplary graphical user interface 325 pertaining to collections 227 (as illustrated in FIG. 2B). Collections 227 allows user 155 to create a content collection, which may populate a space within a content package promotion. The content collection may include a collection of content that share a common theme. Additionally, user 155 may create a collection within a collection (e.g., a sub-collection). For example, a collection titled “Super Agents” may include sub-collections titled “James Bond”, “Jason Bourne”, etc. User 155 may create a collection within any of the modules listed in module menu 205. Referring to FIG. 3E, graphical user interface 325 includes a name field 305-1, which allows user 155 to name the collection (e.g., The James Bond Collection). A description field 327-1 provides a pop-up window (not illustrated) that allows user 155 to enter a description of the collection. For example, user 155 may provide information about the collection of content offered in a content package promotion, such as the theme of the content package or details about each content included in the collection of content. Image URL field 323-3, title selection and sort field 305-11, start field 305-4, end field 305-6, price field 327-3, status field 305-9, save button 307-1, reset button 307-2, cancel button 307-3, and delete button 307-4 provide similar functionalities as those previously described elsewhere in this description. A destination URL field 327-2 allows user 155 to enter a network address (URL). For example, user 155 may enter a network address that directs customers to a specific website containing the content rather than to an internal collection page of the service provider.

Although not illustrated, a graphical user interface for my-list module 216 includes a name field that allows user 155 to name the content promotion. Since the content has already been selected by the customer (e.g., bookmarked content, favorite content, etc.), user 155 may drag-and-drop my-list module 216 at a location in a candidate graphical user interface directed to the customer.

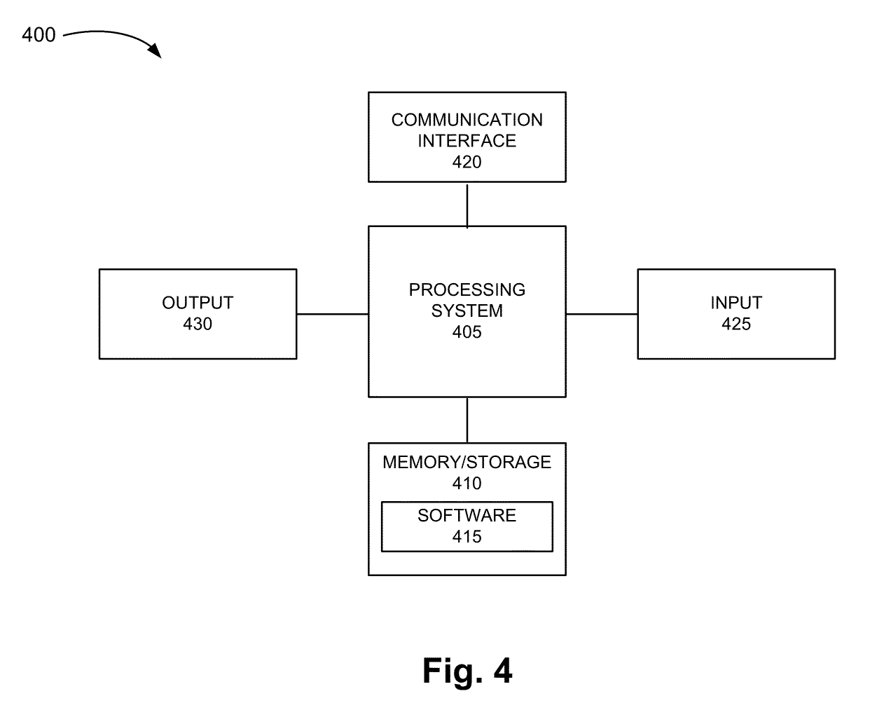

FIG. 4 is a diagram illustrating exemplary components of a device 400 that may correspond to one or more of the devices in environment 100. For example, device 400 may correspond to content merchandising system 105, discovery engine 110, analytics engine 115, content management system 120, as well as other devices illustrated and described. As illustrated in FIG. 4, according to an exemplary embodiment, device 400 includes a processor 405, memory/storage 410 that stores software 415, a communication interface 420, an input 425, and an output 430. According to other embodiments, device 400 may include fewer components, additional components, different components, and/or a different arrangement of components than those illustrated in FIG. 4 and described herein.

Processor 405 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 405 may be implemented as hardware (e.g., a microprocessor, etc.), a combination of hardware and software (e.g., a SoC, an ASIC, etc.), may include one or multiple memories (e.g., cache, etc.), etc.

Processor 405 may control the overall operation or a portion of operation(s) performed by device 400. Processor 405 may perform one or multiple operations based on an operating system and/or various applications or computer programs (e.g., software 415). Processor 405 may access instructions from memory/storage 410, from other components of device 400, and/or from a source external to device 400 (e.g., a network, another device, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 410 may include a hard disk (e.g., a magnetic disk, an optical disk, a magneto-optic disk, a solid state disk, etc.) and a corresponding drive. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray® disk (BD), etc.). Memory/storage 410 may store data, software, and/or instructions related to the operation of device 400.

Software 415 includes an application or a program that provides a function and/or a process. As an example, with reference to content merchandising system 105, software 415 may include an application that, when executed by processor 405, provides the functions of the content merchandising service, as described herein. By way of further example, software 415 of content merchandising system 105 may be implemented using a combination of Web services, JavaScript, and HTML-5. Software 415 is also intended to include firmware, middleware, microcode, hardware description language (HDL), and/or other form of instruction. Software 415 is also intended to include other types of functional elements, such as application programming interfaces (APIs), etc.

Communication interface 420 permits device 400 to communicate with other devices, networks, systems, and/or the like. Communication interface 420 includes one or multiple wireless interfaces and/or wired interfaces. For example, communication interface 420 may include one or multiple transmitters and receivers, or transceivers. Communication interface 420 may operate according to a protocol stack and a communication standard.

Input 425 permits an input into device 400. For example, input 425 may include a keyboard, a mouse, a display, a touchscreen, a touchless screen, a button, a switch, an input port, speech recognition logic, and/or some other type of visual, auditory, tactile, etc., input component. Output 430 permits an output from device 400. For example, output 430 may include a speaker, a display, a touchscreen, a touchless screen, a light, an output port, and/or some other type of visual, auditory, tactile, etc., output component.

Device 400 may perform a process and/or a function, as described herein, in response to processor 405 executing software 415 stored by memory/storage 410. By way of example, instructions may be read into memory/storage 410 from another memory/storage 410 (not shown) or read from another device (not shown) via communication interface 420. The instructions stored by memory/storage 410 cause processor 405 to perform a process described herein. Alternatively, for example, according to other implementations, device 400 performs a process described herein based on the execution of hardware (processor 405, etc.).

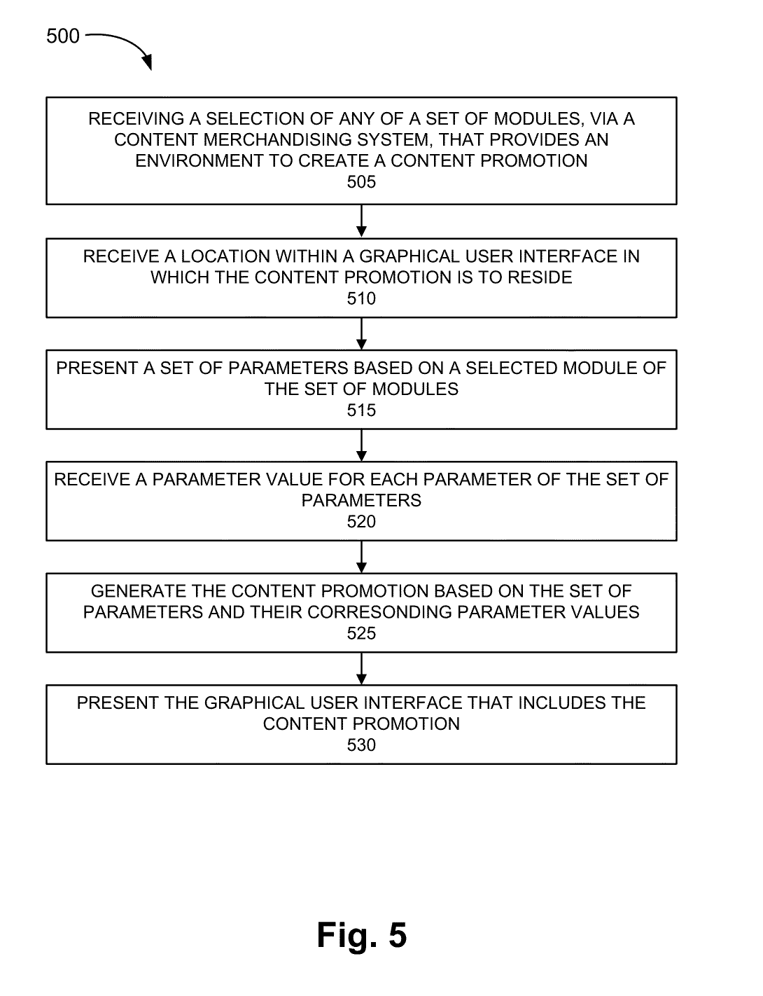

FIG. 5 is a flow diagram illustrating an exemplary process 500 pertaining to the content merchandising service of content merchandising system 105. Process 500 is directed to a process previously described above with respect to FIGS. 2C-2G, as well as elsewhere in this description, in which a user establishes a session with content merchandising system 105, via end device 150, and creates a content package promotion. According to an exemplary embodiment, content merchandising system 105 performs steps of process 500. For example, processor 405 executes software 415 to perform the steps described.

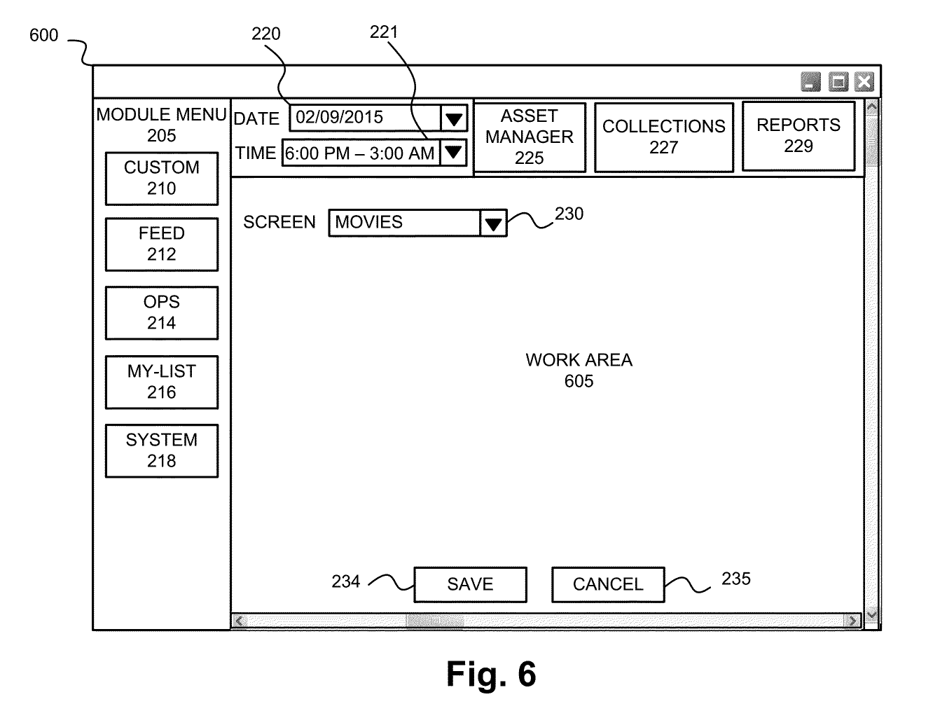

Referring to FIG. 5, in block 505, process 500 begins with receiving a selection of any of a set of modules, via a content merchandising system, that provides an environment to create a content promotion. For example, a user may establish a communication link and session between end device 150 and content merchandising system 105. Content merchandising system 105 may present a graphical user interface to the user, such as a main graphical user interface 600 illustrated in FIG. 6. Main graphical user interface 600 includes a module menu 205 including custom module 210, feed module 212, operations module 214, my-list module 216, and system module 218. The user may select from any of the modules included in module menu 205 to create the content promotion. Additionally, the user may select collections 227 to create a collection within a selected module.

In block 510, a location within a graphical user interface in which the content promotion is to reside is received. For example, the user may select one of the modules from module menu 205 and drag-and-drop the module at a location within a work area 605 of main graphical user interface 600.

In block 515, a set of parameters based on a selected module of the set of modules is presented. For example, a graphical user interface pertaining to one of custom module 210, feed module 212, operations module 214, my-list module 216, or system module 218 is presented to the user. For example, graphical user interfaces pertaining to custom module 210, feed module 212, operations module 214, and system module 218 have been illustrated in the Figures and described herein.

In block 520, a parameter value for each parameter of the set of parameters presented in the graphical user interface pertaining to the selected module is received. For example, the user selects or enters parameter values for each parameter offered, via the graphical user interface, by the selected module. The user saves and exits the configuration of the content promotion.

In block 525, the content promotion is generated based on the set of parameters and their corresponding parameter values. For example, the selected module of content merchandising system 105 selects content and metadata (e.g., images, text description), name of the content promotion, etc., that adheres to the parameters and their corresponding parameter values provided by the user.

In block 530, the graphical user interface is presented that includes the content promotion. For example, content merchandising system 105 presents to the user the generated content promotion within a graphical user interface.

Although FIG. 5 illustrates an exemplary process 500 of the content merchandising service, according to other embodiments, process 500 may include additional operations, fewer operations, and/or different operations than those illustrated in FIG. 5 and described.

The foregoing description of embodiments provides illustration, but is not intended to be exhaustive or to limit the embodiments to the precise form disclosed. Accordingly, modifications to the embodiments described herein may be possible. For example, although the product to which content merchandising system 105 pertains is content, according to other embodiments, the product can be another type of product in which merchandising promotions may be created.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while a series of blocks has been described with regard to the process illustrated in FIG. 5, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component.” The logic or the component may include, for example, hardware (e.g., processor 405, etc.), or a combination of hardware and software (e.g., software 415). The embodiments have been described without reference to the specific software code since the software code can be designed to implement the embodiments based on the description herein and commercially available software design environments/languages.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The word “exemplary” is used herein to mean “serving as an example.” Any embodiment or implementation described as “exemplary” is not necessarily to be construed as preferred or advantageous over other embodiments or implementations.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 405) of a computational device. A non-transitory storage medium includes one or more of the storage mediums described in relation to memory/storage 410.

No element, act, or instruction described in the present application should be construed as critical or essential to the embodiments described herein unless explicitly described as such.

What is claimed is:

1. A method comprising:
receiving, by a network device, a request from an end device to establish a session pertaining to a creation of a content promotion;
receiving, by the network device, subsequent to an establishment of the session, a selection from a user, via a graphical user interface, of any module from a set of modules that each provides an environment to create the content promotion, wherein the set of modules includes a custom module, a feed module, an operations module, a my-list module, and a system module;
presenting, by the network device, a set of parameters to the user based on the selection of any of the set of modules;
receiving, by the network device, a parameter value, from the user, for each parameter of the set of parameters pertaining to a selected module of the set of modules;
generating, by the network device, the content promotion based on the set of parameters and their corresponding parameter values; and
presenting, by the network device, another graphical user interface that includes the content promotion as would be presented to a customer.

2. The method of claim 1, further comprising:
receiving, by the network device, a location within the graphical user interface in which the content promotion is to reside based on a drag-and-drop of the selected module of the set of modules, and wherein the content promotion pertains to a content package that includes multiple content.

3. The method of claim 1, wherein the feed module allows the user to select a merchandising feed created by a third party as the content promotion, the operations module allows the user to manually search and select content pertaining to the content promotion from a search result, the my-list module allows the user to import customer-selected content, and the system module allows the user to select content based on pre-configured categories of content including popular, top titles, recommendations, recently watched, box office performance, and customer specific.

4. The method of claim 1, wherein the set of parameters of the custom module includes a name of the content promotion, a genre of a content to which the content promotion pertains, a release date of the content, keywords pertaining to a search of the content, an MPAA rating pertaining to the content, a user rating pertaining to the content, a third party rating pertaining to the content, a price of the content, a running time of the content, a start date and time and an end date and time during which the content promotion is available to customers, a time of day during which the content promotion is available to the customers, and an end device type that the content promotion targets.

5. The method of claim 1, wherein the set of parameters of the system module includes a name of the content promotion and a pre-configured category of content, and wherein pre-configured parameter values of the pre-configured category of content include popular, top titles, recommendations, recently watched, box office performance, and customer specific.

6. The method of claim 5, wherein the customer specific indicates content that is linked to a customer based on an attribute of the customer and an attribute of the content.

7. The method of claim 1, wherein the graphical user interface includes a collection function, which when selected, allows the user to create a collection of content pertaining to a common theme.

8. The method of claim 7, wherein the collection function includes a set of parameters including a name of a collection, a description of the collection, a destination address where the content can be obtained by a customer, a start date and time and an end date and time pertaining to a content promotion for the collection, and a price for the collection.

9. A network device comprising:
a communication interface;
a memory, wherein the memory stores instructions; and
a processor, wherein the processor executes the instructions to:
receive, via the communication interface, a request from an end device to establish a session pertaining to a creation of a content promotion;
receive, subsequent to an establishment of the session, a selection from a user, via a graphical user interface, of any module from a set of modules that each provides an environment to create the content promotion, wherein the set of modules includes a custom module, a feed module, an operations module, a my-list module, and a system module;
present a set of parameters to the user based on the selection of any of the set of modules;
receive a parameter value, from the user, for each parameter of the set of parameters pertaining to a selected module of the set of modules;
generate the content promotion based on the set of parameters and their corresponding parameter values; and
present another graphical user interface that includes the content promotion as would be presented to a customer.

10. The network device of claim 9, wherein the processor further executes the instructions to:
receive a location within the graphical user interface in which the content promotion is to reside based on a drag-and-drop of the selected module of the set of modules, and wherein the content promotion pertains to a content package that includes multiple content.

11. The network device of claim 9, wherein the feed module allows the user to select a merchandising feed created by a third party as the content promotion, the operations module allows the user to manually search and select content pertaining to the content promotion from a search result, the my-list module allows the user to import customer-selected content, and the system module allows the user to select content based on pre-configured categories of content including popular, top titles, recommendations, recently watched, box office performance, and customer specific.

12. The network device of claim 9, wherein the feed module allows the user to select a merchandising feed created by a third party as the content promotion, the operations module allows the user to manually search and select content pertaining to the content promotion from a search result, the my-list module allows the user to import customer-selected content, and the system module allows the user to select content based on pre-configured categories of content including popular, top titles, recommendations, recently watched, box office performance, and customer specific.

13. The network device of claim 9, wherein the set of parameters of the custom module includes a name of the content promotion, a genre of a content to which the content promotion pertains, a release date of the content, keywords pertaining to a search of the content, an MPAA rating pertaining to the content, a user rating pertaining to the content, a third party rating pertaining to the content, a price of the content, a running time of the content, a start date and time and an end date and time during which the content promotion is available to customers, a time of day during which the content promotion is available to the customers, and an end device type that the content promotion targets.

14. The network device of claim 9, wherein the set of parameters of the system module includes a name of the content promotion and a pre-configured category of content, and wherein pre-configured parameter values of the pre-configured category of content include popular, top titles, recommendations, recently watched, box office performance, and customer specific, and wherein the customer specific indicates content that is linked to a customer based on an attribute of the customer and an attribute of the content.

15. The network device of claim 9, wherein the graphical user interface includes a collection function, which when selected, allows the user to create a collection of content pertaining to a common theme.

16. A non-transitory, computer-readable storage medium storing instructions executable by a processor of a computational device, which when executed cause the computational device to:
receive a request from an end device to establish a session pertaining to a creation of a content promotion;
receive, subsequent to an establishment of the session, a selection from a user, via a graphical user interface, of any module from a set of modules that each provides an environment to create the content promotion, wherein the set of modules includes a custom module, a feed module, an operations module, a my-list module, and a system module;
present a set of parameters to the user based on the selection of any of the set of modules;
receive a parameter value, from the user, for each parameter of the set of parameters pertaining to a selected module of the set of modules;
generate the content promotion based on the set of parameters and their corresponding parameter values; and
present another graphical user interface that includes the content promotion as would be presented to a customer.

17. The non-transitory, computer-readable storage medium of claim 16, further storing instructions executable by the processor of the computational device, which when executed cause the computational device to:
receive a location within the graphical user interface in which the content promotion is to reside based on a drag-and-drop of the selected module of the set of modules, and wherein the content promotion pertains to a content package that includes multiple content.

18. The non-transitory, computer-readable storage medium of claim 16, wherein the feed module allows the user to select a merchandising feed created by a third party as the content promotion, the operations module allows the user to manually search and select content pertaining to the content promotion from a search result, the my-list module allows the user to import customer-selected content, and the system module allows the user to select content based on pre-configured categories of content including popular, top titles, recommendations, recently watched, box office performance, and customer specific.

19. The non-transitory, computer-readable storage medium of claim 16, wherein the set of parameters of the custom module includes a name of the content promotion, a genre of a content to which the content promotion pertains, a release date of the content, keywords pertaining to a search of the content, an MPAA rating pertaining to the content, a user rating pertaining to the content, a third party rating pertaining to the content, a price of the content, a running time of the content, a start date and time and an end date and time during which the content promotion is available to customers, a time of day during which the content promotion is available to the customers, and an end device type that the content promotion targets.

20. The non-transitory, computer-readable storage medium of claim 16, wherein the set of parameters of the system module includes a name of the content promotion and a pre-configured category of content, and wherein pre-configured parameter values of the pre-configured category of content include popular, top titles, recommendations, recently watched, box office performance, and customer specific, and wherein the customer specific indicates content that is linked to a customer based on an attribute of the customer and an attribute of the content.
